(19) United States
(12) Patent Application Publication
(10) Pub. No.: US 2025/0293497 A1
(43) Pub. Date: Sep. 18, 2025

(54) SQUARE BOX USING MUD RING

(71) Applicant: Hubbell Incorporated, Shelton, CT (US)

(72) Inventors: Krzysztof W. Korcz, Granger, IN (US); Victor Beristany, South Bend, IN (US); Krishna C. Patel, Granger, IN (US)

(21) Appl. No.: 19/078,490

(22) Filed: Mar. 13, 2025

Related U.S. Application Data
(60) Provisional application No. 63/565,864, filed on Mar. 15, 2024.

(51) Int. Cl. H02G 3/08; H02G 3/12

(52) U.S. Cl. CPC H02G 3/081; H02G 3/12

(57) ABSTRACT

An electrical box that includes a bottom wall, a first side wall, and a second side wall. The first side wall extends from the base wall. The second side wall extends from the base wall and is oriented substantially perpendicularly to the first side wall. A first lip extends from the first side wall. The first lip has a first tab with a first opening. A second lip extends from the second side wall. The second lip has a second tab with a second opening. The first lip and the second lip contact at an interface. The interface includes a continuous surface between the first lip and the second lip.

### CROSS-REFERENCE TO RELATED APPLICATION

This application claims the benefit of U.S. Provisional Application No. 63/565,864, filed Mar. 15, 2024, the contents of which is incorporated herein by reference in its entirety.

### FIELD

The present disclosure relates to an electrical box. More particularly, the present disclosure relates to standard-sized mud ring used with a larger electrical box.

### BACKGROUND

Electrical boxes may be manufactured in a variety of sizes based on user needs and/or space constraints. Many boxes may be constructed as square boxes (e.g., having a square opening). These boxes may be 4-inch square box or a 4 11/16-inch square box. These boxes may be manufactured to a specific standard (e.g., a NEMA standard).

Recently, manufactures have constructed 5-inch square boxes, which currently do not have a specific manufacturing standard. As a result, different manufacturers have constructed different versions of the 5-inch square box. For example, mounting apertures used to mount a cover (e.g., a mug ring, a mounting flange, etc.) may be located in different positions based on the specific manufacture. FIG. 15 shows one example of an existing 5-inch square box 10 with mounting apertures 25 located at a first position. Other examples of a 5-inch square box may have one or more of the mounting apertures 25 located at a different location (e.g., different spacing between the mounting apertures 25, different number of mounting apertures 25, and/or different sized mounting apertures 25).

Because each version of the 5-inch square box has mounting apertures 25 in different locations, different mug rings are required to be used with each version of a box. These mud rings are generally low margin products that are difficult to manufacture at large quantities. This means that companies must manufacture mud ring for each specific box, or they must attempt to use existing mud rings designed to accommodate smaller boxes.

As shown in FIGS. 16 and 17, using an existing mud ring designed for a smaller box may not properly engage with the larger 5-inch square box. For example, a 4 11/16-inch mud ring does not entirely fit over an opening of the 5-inch square box. Using the smaller mud ring may create a gap 50 between an edge of the opening and the edge of the mud ring. This gap 50 is generally not permissible under current standards.

There exists a need for a standardized mug ring to be used with larger boxes that do not currently have standards in sizing.

### SUMMARY

Various embodiments of the present disclosure can overcome various of the aforementioned and other disadvantages associated with known electrical boxes and offer new advantages as well.

According to one aspect of various embodiments of the present disclosure there is provided an electrical box having a lip for at least partially supporting a cover.

According to another aspect of various embodiments of the present disclosure, there is provided a five-inch square electrical box having an inner lip that forms an opening with a dimension less than five inches. The lip can support a 4 and 11/16 inch mud ring.

According to another aspect of various embodiments of the present disclosure, there is provided an electrical box that includes a bottom wall, a first side wall, and a second side wall. The first side wall extends from the base wall. The second side wall extends from the base wall and is oriented substantially perpendicularly to the first side wall. A first lip extends from the first side wall. The first lip has a first tab with a first opening. A second lip extends from the second side wall. The second lip has a second tab with a second opening. The first lip and the second lip contact at an interface. The interface includes a continuous surface between the first lip and the second lip.

According to another aspect of various embodiments of the present disclosure, there is provided an electrical box assembly that includes a box and a cover. The box includes a bottom wall and a plurality of side walls that extend from the bottom wall. Each side wall of the plurality of side walls includes a lip that extends toward a center of the bottom wall. The lips form a continuous surface around a perimeter of the box. The cover is selectively mounted to the box against the lips. The cover at least partially overlaps the lips to eliminate a gap between an inner perimeter of the lips and an outer perimeter of the cover.

According to another aspect of various embodiments of the present disclosure, there is provided an electrical box assembly that includes a box and a cover. The box includes a bottom wall and a plurality of side walls that extend from the bottom wall. Each side wall of the plurality of side walls includes a lip. The lips form a continuous surface around a perimeter of the box. Each lip includes a first tab with a first opening and a second tab with a second opening. The cover is selectively mounted to the box against the lips. The cover includes at least one mounting opening that may be aligned with at least one of the first openings or the second openings. The cover at least partially overlaps the lips to eliminate a gap between an inner perimeter of the lips and an outer perimeter of the cover.

According to another aspect of various examples of the present disclosure, there is provided a method of housing an electrical device that includes connecting a cover to an electrical box.

According to another aspect of various embodiments of the present disclosure, there is provided a method of housing an electrical device. The method includes selecting a cover with a first width and selecting between a first electrical box having an outer width equal to the first width and a second electrical box having an outer width greater than the first width. Each electrical box includes a bottom wall and a plurality of side walls extending from the bottom wall. The method also includes connecting the cover to the selected one of the first electrical box and the second electrical box. The cover is positioned opposite to the respective bottom wall. The cover can extend to the outer width of the first electrical box so that no gap exists between the plurality of side walls of the first electrical box and the outer edge of the cover. Each side wall of the plurality of side walls of the second electrical box includes a lip. The lips form a continuous surface around a perimeter of the box. A width between opposing lips is equal to the first width. The cover can overlay at least a portion of the lips of the second electrical box so that no gap exists between the lips of the second electrical box and the outer edge of the cover.

According to another aspect of various embodiments of the present disclosure, there is provided a method of housing an electrical device. The method includes selecting a cover with a first width and a fastening opening and selecting between a first electrical box having an outer width equal to the first width and a second electrical box having an outer width greater than the first width. Each electrical box includes a bottom wall and a side wall extending from the bottom wall. The method further includes positioning the cover over the selected one of the first electrical box and the second electrical box. The cover is positioned opposite to the respective bottom wall. The method also includes connecting the cover to the selected one of the first electrical box and the second electrical box by inserting a fastener through the fastener opening. The cover can extend to the outer width of the first electrical box so that no gap exists between the side wall of the first electrical box and the outer edge of the cover. The side wall of the first electrical box includes a first opening for receiving the fastener. The side wall of the second electrical cover includes a lip having a second opening. The cover can overlay at least a portion of the lips of the second electrical box so that no gap exists between the lips of the second electrical box and the outer edge of the cover. The side wall of the second electrical box includes a second opening for receiving the fastener.

According to another aspect of various embodiments of the present disclosure, there is provided a method of housing an electrical device. The method includes connecting an electrical box to a support via a threaded opening on a first side wall of the electrical box. The method also includes connecting a cover to the electrical box, wherein the cover and the wall at least partially form an internal volume for housing the electrical device. The first side wall is disposed adjacent to a second side wall. The first side wall includes a first lip and the second side wall includes a second lip oriented perpendicular to the first lip. The cover can overlay at least a portion of the first lip and the second lip so that no gap exists between the lips of the electrical box and an outer edge of the cover.

According to another aspect of various embodiments of the present disclosure, there is provided a method of housing an electrical device. The method includes connecting an electrical box to a support via a threaded opening on a bottom wall of the electrical box. The electrical box further includes a first side wall and a second side wall that extend from the bottom wall. The method further includes connecting a cover to the electrical box. The cover, the first side wall, the second side wall, and the bottom wall at least partially form an internal volume for housing the electrical device. The first side wall is disposed adjacent to a second side wall. The first side wall includes a first lip and the second side wall includes a second lip oriented perpendicular to the first lip. The cover can overlay at least a portion of the first lip and the second lip so that no gap exists between the lips of the electrical box and an outer edge of the cover.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a perspective view of an electrical box.

FIG. 2 is a perspective view of side walls of the electrical box of FIG. 1.

FIG. 3 is a top view of the side walls of FIG. 2.

FIG. 4 is a side view of the side walls of FIG. 2.

FIG. 5 is a perspective view of an end wall of the electrical box of FIG. 1.

FIG. 6 is a side view of the end wall of FIG. 5.

FIG. 7 is a perspective view of the electrical box of FIG. 1 with a mud ring attached.

FIG. 8 is a detail view of the electrical box of FIG. 7.

FIG. 9 is a first perspective view of an electrical box according to another example.

FIG. 10 is a second perspective view of the electrical box of FIG. 9.

FIG. 11 is a top view of the electrical box of FIG. 9.

FIG. 12 is a side view of the electrical box of FIG. 9.

FIG. 13 is a cross-sectional view of the electrical box of FIG. 11, viewed along section 13-13.

FIG. 14 is a detail view of the electrical box of 13, viewed along detail 14.

FIG. 15 is a perspective view of an electrical box according to a prior example.

FIG. 16 is a perspective view of the prior electrical box of FIG. 15 with a mud ring attached.

FIG. 17 is a detail view from detail 17 of the prior electrical box of FIG. 16.

### DETAILED DESCRIPTION

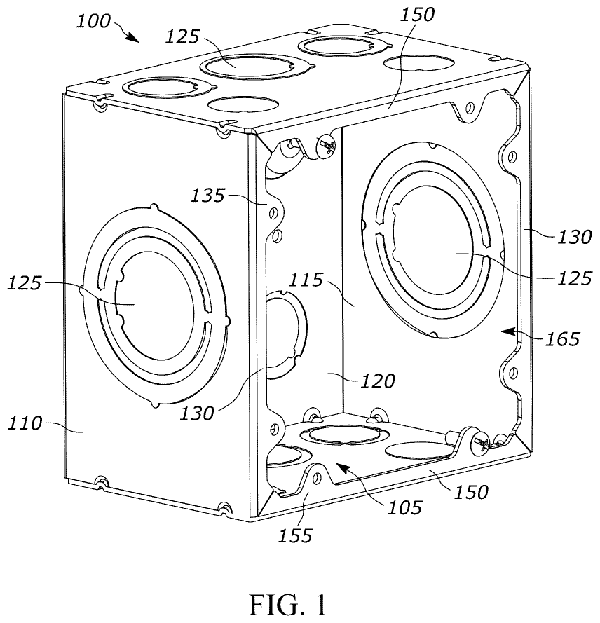

FIG. 1 illustrates an electrical box 100. The electrical box 100 may include a plurality of walls that at least partially form a volume 105. For example, the electrical box 100 may include a pair of side walls 110, a pair of end walls 115, and a bottom wall 120. The illustrated electrical box 100 does not include a top wall (e.g., opposite the bottom wall 120), although other examples may include a top wall. The volume 105 may be formed in the space between the pair of side walls 110, the pair of end walls 115, and the bottom wall 120.

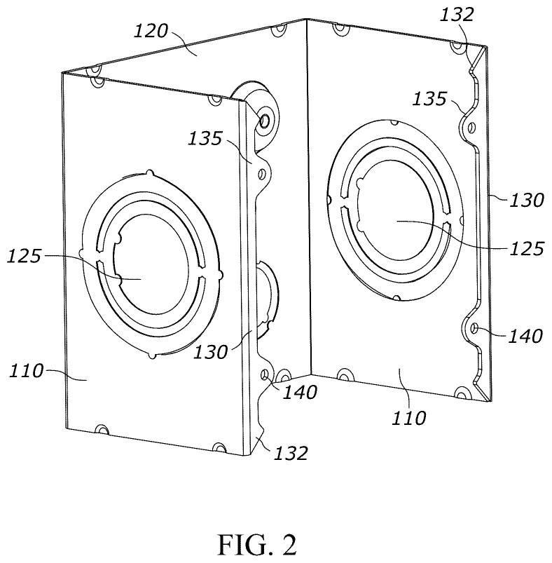

As shown in FIGS. 2 to 4, the side walls 110 may be manufactured in one piece with the bottom wall 120. For example, a single piece of material may be bent (e.g., at substantially right angles) into a substantially C-shape or U-shape. The bottom wall 120 may therefore be between the side walls 110, and all three walls 110, 120 may be integrally formed. However, in other examples, one or more of the side walls 110 may be formed separately from the bottom wall 120.

In some forms, at least one of the walls 110, 120 may include a knockout 125, which may be a selectively removable section of the respective wall 110, 120 to permit ingress and/or egress through the wall 110, 120. In the illustrated example, each of the side walls 110 and the bottom wall 120 may include at least one knockout 125.

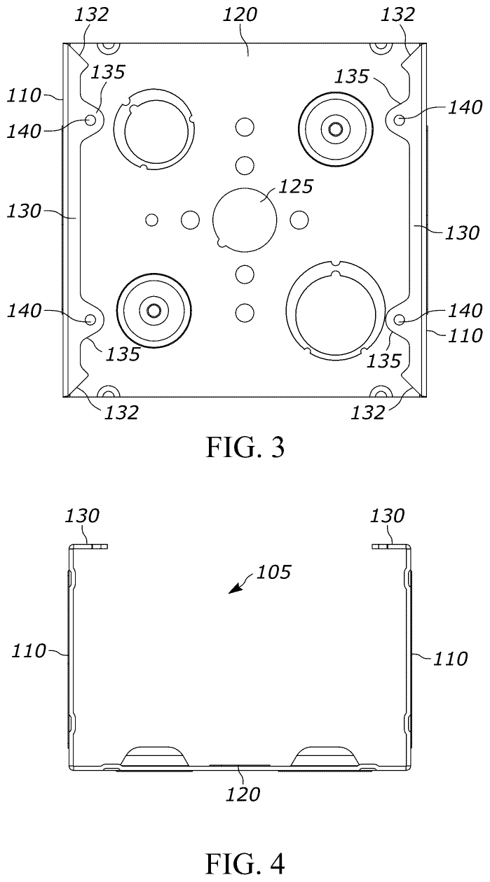

As shown in FIGS. 2 and 3, multiple knockouts 125 may be arranged in a specific pattern across the respected surface. For example, each illustrated side wall 110 may include a single knockout 125 arranged substantially in the center. The bottom wall 120 five larger knockouts 125 arranged in a X-shape. Smaller knockouts 125 may be arranged in a cross shape between the larger knockouts 125. In other examples, one or more of the walls 110, 120 may have a different pattern (e.g., a different number and/or size) of knockouts 125.

With continued reference to FIGS. 2 to 4, each of the side walls 110 may be formed as a cantilever structure relative to the bottom wall 120. In some forms, a lip 130 may be formed at the free end of each of the side walls 110. Each lip 130 may be similarly integrally formed as one piece with the respective side wall 110.

In some forms, each lip 130 may be formed via a bend (e.g., at substantially right angles with the respective side wall 110). The illustrated lips 130 may be bent toward one another (e.g., toward the center of the bottom wall 120). However, other examples may include one or more of the lips 130 bent away from the center of the center of the bottom wall 120.

In certain forms, ends of each lip 130 may include an angled wall 132, which may extend at an oblique angle relative to the remainder of the side wall 110. In the illustrated example, the angled walls 132 may be directed toward one another (e.g., the lip 130 may include a substantially trapezoidal shape). However, in other examples, the angled walls 132 may be parallel to one other or may be oriented at different angles relative to the remainder of the side wall 110.

In some forms, each lip 130 may include one or more tabs 135 (e.g., two shown), which may project away from the respective side wall 110. Each projection may have a curved shape and may include an aperture 140.

As shown in FIG. 3, a tab 135 on one lip 130 may be aligned with a tab 135 on the opposite lip 130. Additionally, the tabs 135 on one lip may be spaced apart the same distance as the tabs 135 on the other lip 135. As described in more detail below, this may assist in using the apertures 140 to mount an additional device to the electrical box 100.

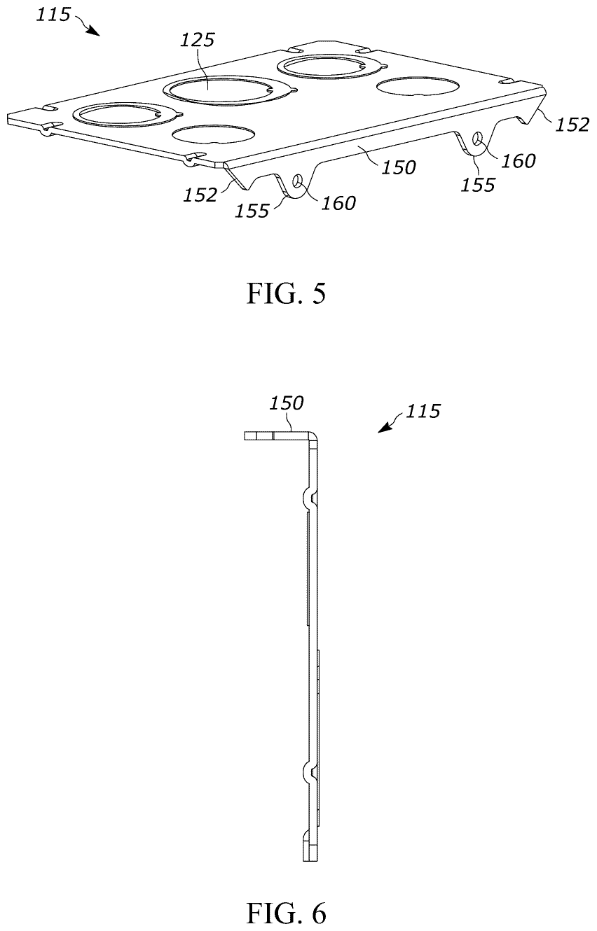

As shown in FIGS. 5 and 6, each of the end walls 115 may be manufactured as a separate piece from the combination side and bottom walls 110, 120. However, other examples may include one or more end walls 115 that are integrally formed with the side walls 110 and/or bottom wall 120.

In some forms, at least one of the end walls 115 may include a knockout 125, which may be a selectively removable section of the respective end wall 115 to permit ingress and/or egress through the end wall 115. In the illustrated example, each of the end walls 115 may include at least one knockout 125. In the illustrated example, each end wall 115 includes five knockouts 125, which are arranged in two rows with three larger knockouts 125 on a bottom row and two smaller knockouts 125 on the upper row. However, other examples of either end wall 115 may include a different number of knockouts 125 and/or a different arrangement of knockouts 125.

In some forms, each of the end walls 115 may include a lip 150 formed at one end. The lip 150 may be similar to the lip 130 formed at the free end of the side wall 110. For example, the lip 150 may be bent (e.g., at a substantially right angle-see e.g., FIG. 6) away from the remainder of the end wall 115.

In certain forms, each lip 150 may include one or more tabs 155 (e.g., two shown), which may project away from the respective end wall 115. Each projection may have a curved shape and may include an aperture 160. The tabs 155 may be similarly shaped to the tabs 135.

As shown in FIG. 1, a tab 155 on one lip 150 may be aligned with a tab 155 on the opposite lip 150. Additionally, the tabs 155 on one lip may be spaced apart the same distance as the tabs 155 on the other lip 155. As described in more detail below, this may assist in using the apertures 160 to mount an additional device to the electrical box 100.

Returning to FIG. 5, certain forms of the ends of each lip 150 may include an angled wall 152, which may extend at an oblique angle relative to the remainder of the end wall 115. In the illustrated example, the angled walls 152 may be directed toward one another (e.g., the lip 150 may include a substantially trapezoidal shape). However, in other examples, the angled walls 152 may be parallel to one other or may be oriented at different angles relative to the remainder of the end wall 115.

Returning to FIG. 1, the end walls 115 may be connected to the side walls 110 and/or end wall 120. For example, each end wall 115 may be connected between the side walls 110 and positioned opposite the other end wall 115. In some forms, this connection may be formed without an additional connector (e.g., via a snap fit, via welding, etc.). In other forms, a connector (e.g., a fastener) may be used to connect the different walls together.

In some forms, an angled wall 132 of the side wall 110 may be formed at the complementary angle as the angled wall 152 of the end wall 115. For example, each angled wall 132, 152 may be formed at about a 45-degree angle, although any complementary angle pair may be used. When the end wall 115 is connected between the side walls 110, the angled walls 152 of each end wall 115 may mate with the respective angled walls 132 of the side walls 110.

This may form a substantially complete perimeter around an opening 165 to the electrical box 110. For example, there may be substantially no gaps between the different lips 130, 150 because the angled walls 132, 152 are substantially flush. In other words, the seams between the lips 130, 150 are substantially complete and smooth.

Once assembled, the width of the opening 165 may be less than the maximum distance between opposing pairs of walls 110, 115. For example, the side walls 110 may be spaced apart from one another by a first distance and the end walls 115 may be spaced apart from one another by a second distance. In the illustrated example, the first distance and the second distance are substantially equal (e.g., bottom wall 120 is a square). Specifically, the electrical box 100 may be a five-inch square box.

In other examples, the first distance and the second distance may be unequal. Alternatively or additionally, the first distance and/or the second distance may be greater than or less than five inches (e.g., between about 0.05 inches and about 5 inches and/or between about 5 inches and about 24 inches).

The width of the opening 165 is less than this distance as a result of the extension of the lips 130, 150. For example, the lips 130, 150 extend toward a center of the electrical box 100. The free end of each lip 130, 150 may together form an inner perimeter. The distance across the opening 165 between the opposing lips 130 may be less than the first distance (i.e., the first distance minus the combined length of lips 130) and the distance across the opening 165 between opposing lips 150 may be less than the second distance (i.e., the second distance minus the combined length of lips 150).

In some forms, the length of each lip 130, 150 may be the same so that the opening 165 may have a substantially square shape. For example, the opening 165 may have a width between about 5 inches and about 1 inch. In some forms, the opening 165 may have a width between about 4.95 inches and about 2 inches. In some forms, the opening 165 may have a width between about 4.75 inches and about 4 inches. In some forms, the opening 165 may have a width between about 4.7 inches and about 4.6 inches. In some forms, the opening 165 may have a width of about 4.6875 inches.

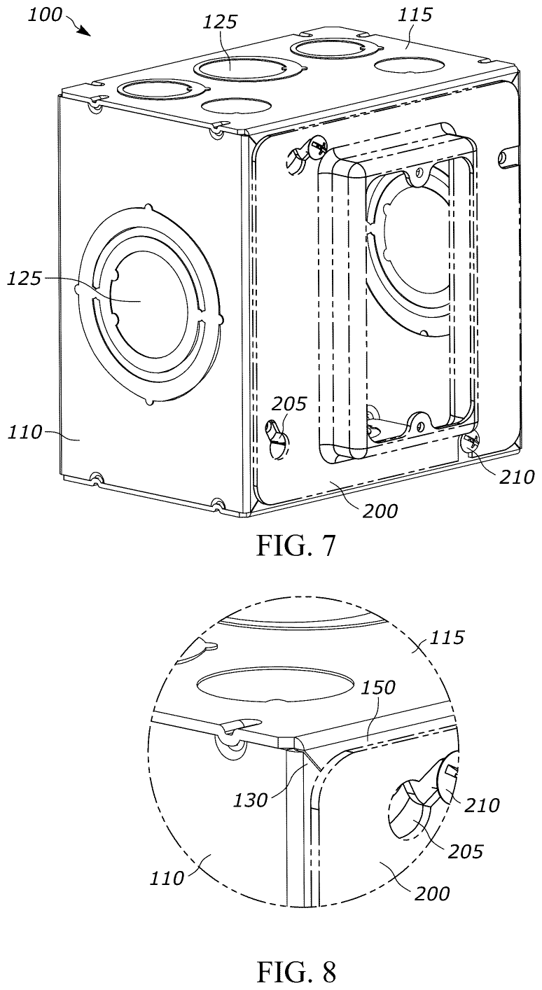

As shown in FIGS. 7 and 8, a cover 200 (e.g., a mud ring) may be attached to the electrical box 100 opposite of the bottom wall 120. Specifically, the cover 200 may be positioned over the opening 165 to substantially enclose the volume within the electrical box 100.

In some forms, the cover 200 may contact the lips 130, 150 when enclosing the volume of the electrical box 100. For example, the cover 200 and the lips 130, 150 may overlap. As shown in FIG. 8, the cover 200 may extend at least partially across each of the lips 130, 150 and may be flush and across the surfaces. Additionally, because the interface between the angled surfaces 132, 152 is substantially smooth, there may be no gap between the cover 200 and lips 130, 150 at the interface.

The lips 130, 150 may permit the use of covers 200 that have a dimension (e.g., length and/or width) that is than the first distance and/or the second distance of the electrical box 100. For example, a cover 200 that has a length and/or width less than five inches may be used with an electrical box 100 that has a first distance and/or a second distance that is at least five inches.

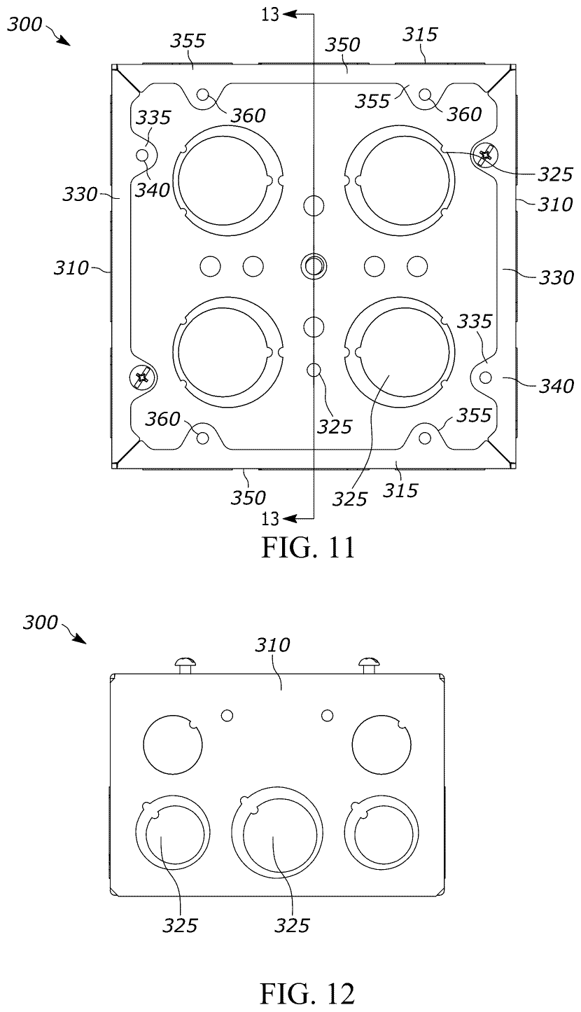

Specifically, square covers 200 having a length and width dimension of about 4.6875 inches may be presently manufactured because of standard requirements. Utilizing the lips 130, 150 permits these covers 200 to be used with larger electrical boxes 100 that are needed to house larger and/or more electrical components in the enclosed volume. More specifically, the lips 130, 150 substantially eliminate gaps between the cover 200 and the walls 110, 115 (e.g., compare FIG. 8 with FIG. 11), which may be necessary to conform to industry standards.

Returning to FIG. 7, the cover 200 may include openings 205 proximate to the outer perimeter. When the cover 200 is positioned against the lips 130, 150, the openings 205 may be aligned with at least some of the apertures 140, 160 in the tabs 135, 155. For example, the tabs 135, 155 may be formed to correspond to the standard position of the openings 205 in an existing cover 200 (e.g., a square 4.6875-inch cover). A fastener 210 may be inserted through a corresponding opening 205 and aperture 140, 160 to secure the cover 200 in position.

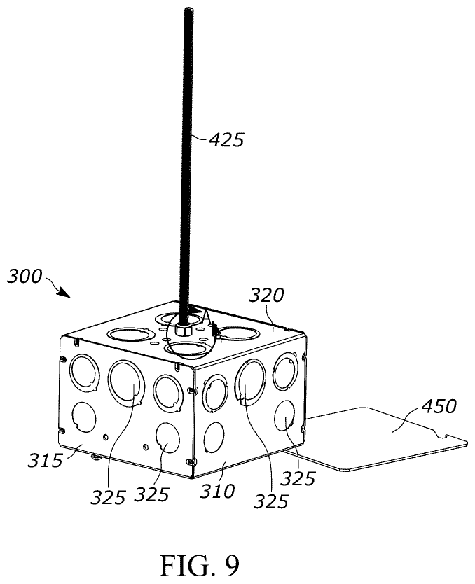

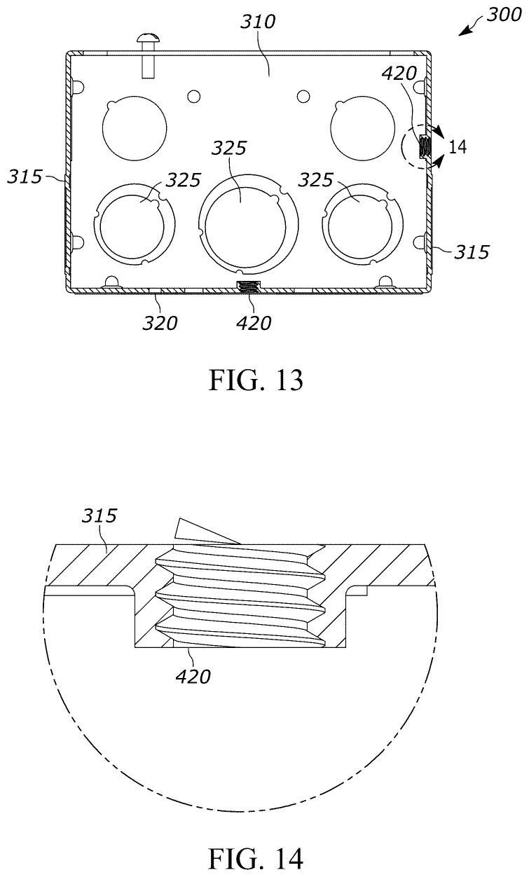

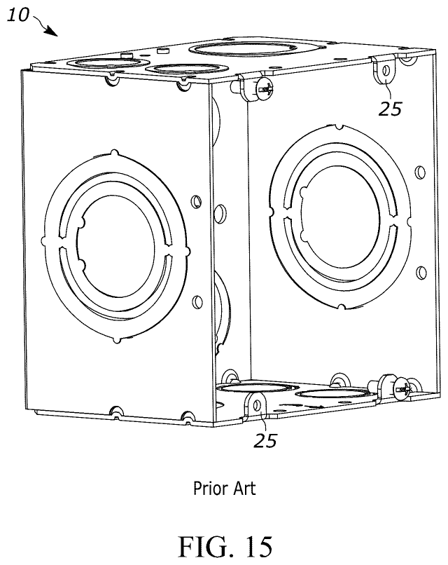

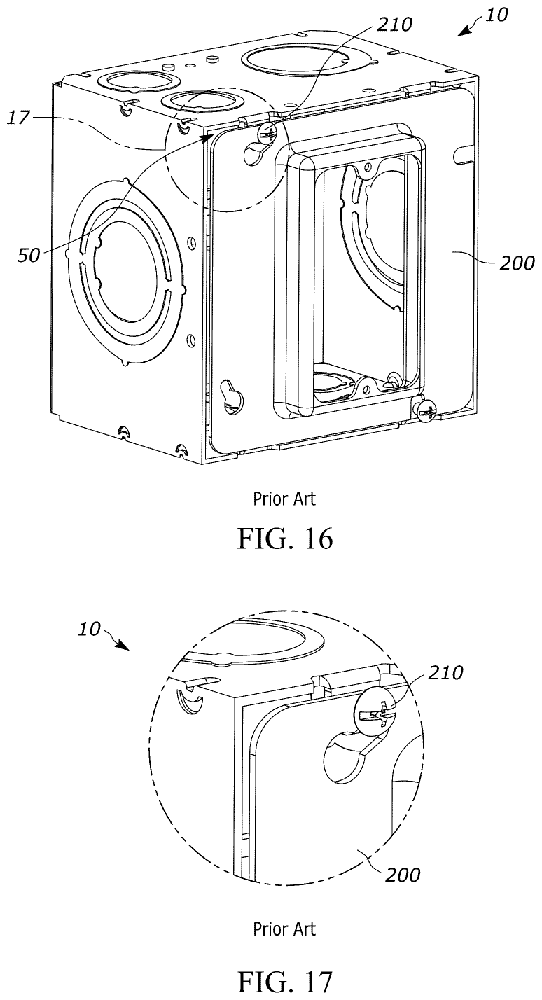

FIGS. 9 to 14 illustrate an alternate example of an electrical box. The electrical box 300 of FIGS. 9 to 14 may be substantially similar to the electrical box 100. Only some similarities and differences are described below. Similar features include the same reference number, plus “200”.

FIG. 9 illustrates an electrical box 300 that may include a plurality of walls that at least partially form a volume 305. For example, the electrical box 300 may include a pair of side walls 310, a pair of end walls 315, and a bottom wall 320. The illustrated electrical box 300 does not include a top wall (e.g., opposite the bottom wall 320), although other examples may include a top wall. The volume 305 may be formed in the space between the pair of side walls 310, the pair of end walls 315, and the bottom wall 320. The side walls 310 may be manufactured integrally and in one piece with the bottom wall 120, or one or more of the side walls 310 may be manufactured separately.

In some forms, at least one of the walls 310, 320 may include a knockout 325, which may be a selectively removable section of the respective wall 310, 320 to permit ingress and/or egress through the wall 310, 320. In the illustrated example, each of the side walls 310 and the end wall 320 may include at least one knockout 325.

In the illustrated example, the electrical box 300 may have a different number and/or pattern of knockouts 325 as compared to the electrical box 100. For example, the pair of side walls 310 and the pair of end walls 315 may have the same number of knockouts 325. More specifically, the illustrated side walls 310 may have a greater number of knockouts 325 than the side walls 110 so that the side walls 310 and the end walls 315 have a similar number of knockouts 325. As shown in FIG. 9, the side walls 310 may have a similar number and pattern of knockouts as the end walls 115. In other examples, each individual wall 310, 315 may have a different number of knockouts 325 (e.g., either greater or fewer) than what is illustrated in the electrical box 100.

In some forms, the pattern of the knockouts 325 on the bottom wall 320 may be similar to the pattern of knockouts 125 on the bottom wall 120. However, the illustrated bottom wall 320 may include a smaller central knockout 325 as compared to the bottom wall 120. In other examples, a different number of knockouts 325 and/or size of knockouts 325 may be used.

In some forms, each of the side walls 310 may be formed as a cantilever structure relative to the bottom wall 320. In some forms, a lip 330 may be formed at the free end of each of the side walls 310. Each lip 330 may be similarly integrally formed as one piece with the respective side wall 310.

As shown in FIG. 11, each lip 330 may be formed via a bend (e.g., at substantially right angles with the respective side wall 310). The illustrated lips 330 may be bent toward one another (e.g., toward the center of the bottom wall 320). However, other examples may include one or more of the lips 330 bent away from the center of the center of the bottom wall 320.

In some forms, each lip 330 may include one or more tabs 335 (e.g., two shown), which may project away from the respective side wall 310. Each projection may have a curved shape and may include an aperture 340. A tab 335 on one lip 330 may be aligned with a tab 335 on the opposite lip 330.

In some forms, each of the end walls 315 may include a lip 350 formed at one end. The lip 350 may be similar to the lip 330 formed at the free end of the side wall 110. For example, the lip 350 may be bent (e.g., at a substantially right angle) away from the remainder of the end wall 315.

In certain forms, each lip 350 may include one or more tabs 355 (e.g., two shown), which may project away from the respective end wall 315. Each projection may have a curved shape and may include an aperture 360. The tabs 355 may be similarly shaped to the tabs 335. A tab 355 on one lip 350 may be aligned with a tab 355 on the opposite lip 350.

In some forms, the end walls 315 may be connected to the side walls 310 and/or end wall 320. For example, each end wall 315 may be connected between the side walls 310 and positioned opposite the other end wall 315. In some forms, this connection may be formed without an additional connector (e.g., via a snap fit, via welding, etc.). In other forms, a connector (e.g., a fastener) may be used to connect the different walls together.

This may form a substantially complete perimeter around an opening 365 to the electrical box 310. For example, there may be substantially no gaps between the different lips 330, 350 and the seams between the lips 330, 350 are substantially complete and smooth.

As shown in FIGS. 11 and 12, one or more of the walls 310, 315, 320 of the may include a threaded opening 420. In the illustrated example, the threaded opening 420 may be a quarter inch 20 UNC thread, however other examples may include other types and/or sizes of threads.

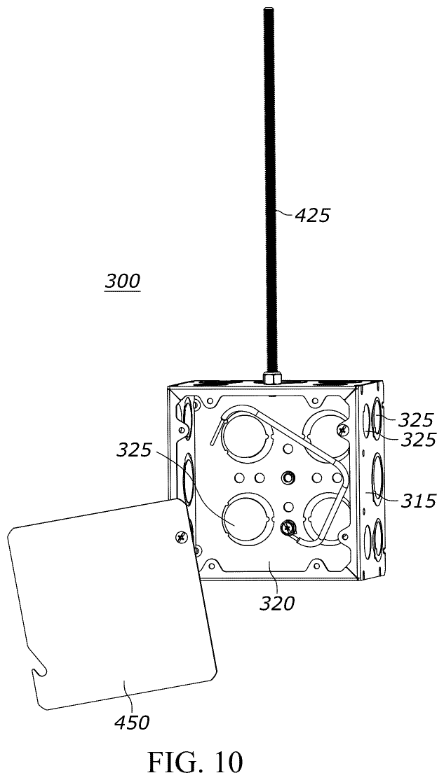

As shown in FIGS. 9 and 10, a support rod 425 may be connected to the electrical box 300 via the threaded opening 420. For example, the support rod 425 may extend from a surface like a ceiling and may allow the electrical box 300 to be suspended. A threaded opening 420 may be on multiple walls 310, 315, 320 so that the electrical box 300 can be oriented in multiple orientations.

Once assembled, the width of the opening 365 may be less than the maximum distance between opposing pairs of walls 310, 315. For example, the side walls 310 may be spaced apart from one another by a first distance and the end walls 315 may be spaced apart from one another by a second distance. In the illustrated example, the first distance and the second distance are substantially equal (e.g., bottom wall 320 is a square). Specifically, the electrical box 300 may be a five-inch square box.

In other examples, the first distance and the second distance may be unequal. Alternatively or additionally, the first distance and/or the second distance may be greater than or less than five inches (e.g., between about 0.05 inches and about 5 inches and/or between about 5 inches and about 24 inches).

The width of the opening 365 is less than this distance because of the extension of the lips 330, 350. For example, the lips 330, 350 extend toward a center of the electrical box 300. The free end of each lip 330, 350 may together form an inner perimeter. The distance across the opening 365 between the opposing lips 330 may be less than the first distance (i.e., the first distance minus the combined length of lips 330) and the distance across the opening 365 between opposing lips 350 may be less than the second distance (i.e., the second distance minus the combined length of lips 350).

In some forms, the length of each lip 330, 350 may be the same so that the opening 365 may have a substantially square shape. For example, the opening 365 may have a width between about 5 inches and about 1 inch. In some forms, the opening 365 may have a width between about 4.95 inches and about 2 inches. In some forms, the opening 365 may have a width between about 4.75 inches and about 4 inches. In some forms, the opening 365 may have a width between about 4.7 inches and about 4.6 inches. In some forms, the opening 365 may have a width of about 4.6875 inches.

The cover 200 (e.g., a mud ring) may be attached to the electrical box 100 opposite of the bottom wall 120. Specifically, the cover 200 may be positioned over the opening 365 to substantially enclose the volume within the electrical box 300. The cover 200 may be substantially the same cover 200 as illustrated in FIGS. 7 and 8, although other examples of the cover may be used. For example, a planar cover 450 (see e.g., FIGS. 9 and 10) may be used. The planar cover 450 may be similar to the walls 310, 315, 320 and may be used prior to installation and can be removed and replaced with the cover 200.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the disclosure may be practiced other than as specifically described.

What is claimed is:

1. An electrical box comprising:
a bottom wall;
a first side wall extending from the base wall;
a second side wall extending from the base wall and oriented substantially perpendicularly to the first side wall;
a first lip extending from the first side wall, the first lip having a first tab with a first opening; and
a second lip extending from the second side wall, the second lip having a second tab with a second opening;
wherein the first lip and the second lip contact at an interface; and
wherein the interface includes a continuous surface between the first lip and the second lip.

2. The electrical box of claim 1, wherein the first lip includes a first end with a first angled edge and the second lip includes a second end with a second angled edge, wherein the first angled edge and the second angled edge are formed at complimentary angles, wherein the first angled edge contracts the second angled edge to form the interface, and wherein the first angled edge is formed at the same angle as the second angled edge.

3. (canceled)

4. The electrical box of claim 1, further comprising:
a third side wall extending from the base wall and oriented substantially parallel to the first side wall;
a fourth side wall extending from the base wall and oriented substantially perpendicularly to the third side wall and to the first side wall;
a third lip extending from the third side wall, the third lip having a third tab with a third opening; and
a fourth lip extending from the fourth side wall, the fourth lip having a fourth tab with a fourth opening;
wherein the first, second, third, and fourth lips form a continuous surface around a perimeter of the electrical box.

5. The electrical box of claim 1, wherein:
the first lip further includes a third tab with a third opening and the second lip further includes a fourth tab with a third opening;
a distance between the first tab and the third tab is the same as the distance between the second tab and the fourth tab; and
a distance between the first tab and the second tab is less than the distance between the first tab and the third tab.

6. The electrical box of claim 1, wherein at least one of the bottom wall, the first side wall, and the second side wall includes a threaded opening configured to selectively receive a support for suspending the electrical box.

7. An electrical box assembly comprising:
a box including:
a bottom wall, and
a plurality of side walls extending from the bottom wall, wherein each side wall of the plurality of side walls includes a lip that extends toward a center of the bottom wall,
wherein the lips form a continuous surface around a perimeter of the box; and
a cover selectively mounted to the box against the lips;
wherein the cover at least partially overlaps the lips to eliminate a gap between an inner perimeter of the lips and an outer perimeter of the cover.

8. The electrical box assembly of claim 7, wherein each lip includes at tab with an opening, and wherein the cover includes at least one mounting opening configured to align with an opening of a tab.

9. The electrical box assembly of claim 7, wherein the lip of a first wall of the plurality of side walls includes a first end and a first angled edge, and the lip of a second wall of the plurality of walls includes a second end and a second angled edge, wherein the first angled edge and the second angled edge are formed at complimentary angles, and wherein the first angled edge contracts the second angled edge to form a continuous interface.

10. The electrical box assembly of claim 9, wherein the cover is configured to be positioned to at least partially overlap the interface, and wherein the first angled edge is formed at the same angle as the second angled edge.

11. (canceled)

12. The electrical box assembly of claim 7, wherein the box is selected from a group of boxes having a large size and a small size, and wherein the cover is configured to connect to either the large size or the small size.

13. The electrical box assembly of claim 7, wherein the box is a 5-inch square box and the cover is a 4 11/16 inch mud plate.

14. The electrical box assembly of claim 7, wherein at least one of the bottom wall and the plurality of side walls includes a threaded opening configured to selectively receive a support for suspending the electrical box.

15. An electrical box assembly comprising:
a box including:
a bottom wall, and
a plurality of side walls extending from the bottom wall, wherein each side wall of the plurality of side walls includes a lip, wherein the lips form a continuous surface around a perimeter of the box, and wherein each lip includes a first tab with a first opening and a second tab with a second opening; and
a cover selectively mounted to the box against the lips, wherein the cover includes at least one mounting opening configured to be aligned with at least one of the first openings or the second openings;
wherein the cover at least partially overlaps the lips to eliminate a gap between an inner perimeter of the lips and an outer perimeter of the cover.

16. The electrical box assembly of claim 15, wherein a first wall of the plurality of walls includes a first lip with a first end and a first angled edge, and a second wall of the plurality of walls includes a second lip with a second end and a second angled edge, wherein the first angled edge and the second angled edge are formed at complimentary angles, and wherein the first angled edge contracts the second angled edge to form a continuous interface.

17. The electrical box assembly of claim 16, wherein the cover is configured to be positioned to at least partially overlap the interface, and wherein the first angled edge is formed at the same angle as the second angled edge.

18. (canceled)

19. The electrical box assembly of claim 15, wherein the box is selected from a group of boxes having a large size and a small size, and wherein the cover is configured to connect to either the large size or the small size.

20. The electrical box assembly of claim 15, wherein the box is a 5-inch square box and the cover is a 4 11/16 inch mud plate.

21. The electrical box assembly of claim 15, wherein:
a distance between the first tab and the second tab on a first wall of the plurality of walls is the same as the distance between the first tab and the second tab on a second wall of the plurality of walls, wherein the first wall is adjacent to the second wall; and
a distance between the first tab on the first wall and the first tab on the second wall is less than the distance between the first tab and the second tab on the first wall.

22. The electrical box assembly of claim 15, wherein the plurality of walls includes a first wall and a second walls, wherein the first wall and the second walls are adjacent to one another and oriented substantially perpendicularly to one another.

23. The electrical box assembly of claim 15, wherein at least one of the bottom wall and the plurality of side walls includes a threaded opening configured to selectively receive a support for suspending the electrical box.

24.-36. (canceled)
